(19) United States
(12) Patent Application Publication
(10) Pub. No.: US 2017/0153907 A1
(43) Pub. Date: Jun. 1, 2017

(54) Out-of-band Management Of Virtual Machines

(71) Applicants: Rajeev Grover, Rocklin, CA (US); John Edward Nolan, Sacramento, CA (US); Todd Joseph Kjos, Los Altos, CA (US)

(72) Inventors: Rajeev Grover, Rocklin, CA (US); John Edward Nolan, Sacramento, CA (US); Todd Joseph Kjos, Los Altos, CA (US)

(21) Appl. No.: 14/955,937

(22) Filed: Dec. 1, 2015

(51) Int. Cl. G06F 9/455

(52) U.S. Cl. CPC G06F 9/45558; G06F 2009/45595

(57) ABSTRACT

A management module of a managed computer is accessed via an out-or-band network. The management module communicates via a hypervisor with guest operating systems running in virtual machines on said managed computer.

This is a divisional of copending U.S. application Ser. No. 12/494,861, filed 2009 Jun. 30, and which is incorporated herein by reference.

### BACKGROUND

Herein, related art is described for expository purposes. Related art labeled “prior art”, if any, is admitted prior art; related art not labeled “prior art” is not admitted prior art.

Large computer installations often provide for remote management of computers. Remote access can be had over a network, e.g., over an “in-band” network used by managed computers to communicate with each other, or over a dedicated “out-of-band” network. In the latter case, a managed computer can be outfitted with a management module dedicated to management over the out-of-band network.

This management module can be a computer within a computer, with its own processor, communications interfaces, and storage. The management module and host computer may communicate over one or more channels. For example, an administrator can configure the host computer and its operating system through the management module. Furthermore, a management module can log events generated by host hardware and software and make the resulting logs available to a system administrator.

The management module can have its own power supply, in which case, it may be referred to as a “lights-out module” (LOM). In the event of a host system failure, the host system can be shut down, event logs can be accessed to determine causes of failure, and the host system can be reconfigured and restarted, all through the management module.

### BRIEF DESCRIPTION OF THE DRAWINGS

FIG. 1 is a schematic diagram of a computer system embodiment in which virtual machines are managed through a management module.

FIG. 2 is a flow chart of a first series of method segments of an instance of a method implemented in the context of the system of FIG. 1.

FIG. 3 is a flow chart of a second series of method segments of the method instance of FIG. 2.

FIG. 4 is a flow chart of a third series of method segments of the method instance of FIG. 2.

FIG. 5 is a graphical representation of a mapping of operating systems to virtual machines and virtual machines to hardware resources.

### DETAILED DESCRIPTION

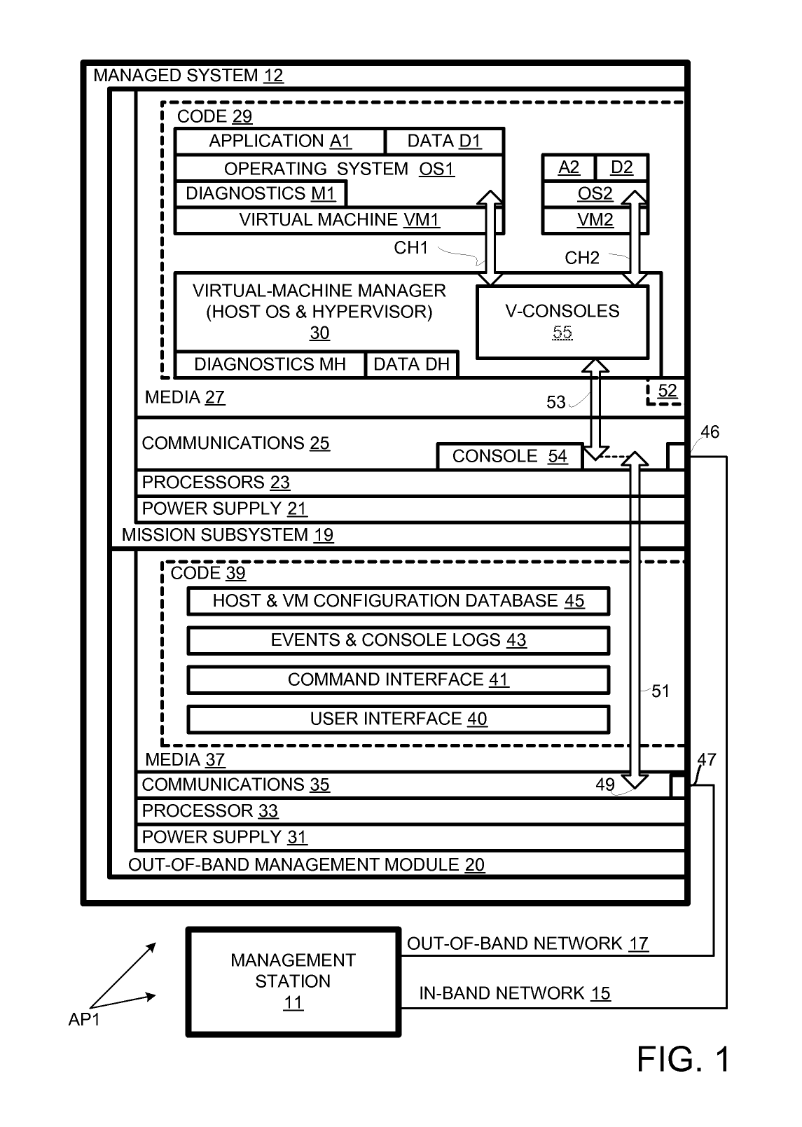

A computer system API, illustrated in FIG. 1, provides for out-of-band management of virtual machines as well as physical computers. Providing a common management interface for both virtual machines and their hosts reduces the number of management interfaces a system administrator must master, and reduces context switching when both virtual machines and their hosts must be managed concurrently. In addition, the provided out-of-band management of virtual machines allows virtual machines to be diagnosed and reconfigured in the event of a hardware, software, or network failure that would prevent in-band management of the virtual machines (e.g., via a hypervisor).

System API includes a management station 11, a managed computer system 12, an in-band network 15, and an out-of-band network 17. In system API, management station 11 is coupled to managed system 12 through both networks 15 and 17. In an alternative embodiment, a management console or workstation is coupled to a managed system only through an out-of-band network. In another alternative embodiment, a management module provides a console directly to log in and manage the system.

Managed system 12 hosts a mission subsystem 19 and an out-of-band management module 20. “Mission” refers to the task or tasks to which a computer's application programs are directed (and as opposed to “management” programs for managing the computer on which the applications are running). Mission subsystem 9 is itself a computer with a power supply 21, processors 23, communications devices 25, and computer-readable storage media 27 (e.g., disks and solid-state memory such as RAM).

Media 27 is encoded with code 29 including computer-readable and manipulable data and programs of computer-executable instructions. Code 29 provides for a virtual-machine manager 30, which serves as a host operating system and a hypervisor. In the illustrated embodiment, the (bare-metal) hypervisor and the host-operating system are one and the same. In an alternative embodiment, the hypervisor and host-operating system are separate entities. In either case, the hypervisor defines and manages virtualization according to configuration data DH. Virtual-machine manager 30 includes virtual consoles 55 and a diagnostic suite MH.

As shown in FIG. 1, virtual-machine manager 30 provides for virtual machines VM1 and VM2. Virtual machine VM1 supports an operating system (instance) OS1, on which an application A1 runs. Operating system OS1 includes a diagnostic suite M1. Application A1 and operating system OS1 have associated data D1. Likewise, an operating system OS2, application A2, data D2 and a diagnostic suite (not shown) are associated with virtual machine VM2.

Out-of-band management module 20 includes a power supply 31, a processor 33, communications devices 35, and computer-readable storage media 37. Media 37 is encoded with code 39, which defines a user interface 40, a command interface 41, events and console logs 43, and a host and virtual-machine configuration database 45. User interface 40 is presented to an administrator accessing module 20. Command interface 41, which is accessible through user interface 40, provides the commands for communicating with mission subsystem 19, hypervisor 30, virtual machines, and guest operating systems. For example, command interface 41 can serve as a common interface to start and stop virtual machines, virtual partitions, and hardware machines.

To monitor the health of mission subsystem 19 and virtual machines VM1 and VM2, logs 43 store diagnostic data received from diagnostics suites for each operating system, including host diagnostics suite MH of virtual-machine manager 30 and diagnostic suite M1 of operating system OS1. In addition, logs 43 store data regarding console interactions with virtual-machine manager 30 and virtual machines VM1 and VM2, as explained further below. When module 20 is used to create virtual machines, allocations of processors, communications devices (I/O), and memory as allocated to respective virtual machines are represented in database 45.

Since module 20 has its own power supply 21, it can be on when mission subsystem 19 is off. This means that, even while mission subsystem 19 is shut down or otherwise inaccessible, an administrator can use management station 11 to access diagnostic and console data stored on module 20 and configure or reconfigure virtual machines. In that case, the virtual machine can access the new configuration data from module 20 the next time they initialize. In an alternative embodiment, a management module shares a power supply with a mission subsystem.

Communications devices 25 include a network interface card 46 coupling mission subsystem 19 to in-band network 17. Communications devices 35 include a network interface 47, which couples module 20 to out-of-band network 17. Communications devices 35 also include a “mission” interface 49 for communication with mission subsystem 19 (via communications devices 25) over channel 51. Channel 51 can include plural subchannels, e.g., a shared storage area 52 for message passing, a serial bus, and video snooping functionality.

A communications pathway between module 20 and virtual-machine manager 30 includes channel 51 and a channel 53, the latter between communications device 25 and virtual-machine manager 30. Virtual-machine manager 30 virtualizes channel 53, e.g., by providing channels CH1 and CH2, respectively, for virtual machines VM1 and VM2. This can be done using PCI Express and virtual I/O technologies. Virtual-machine 30 provides virtual consoles 55 that connect channels CH1 and CH2 to channel 53, thereby enabling communications between module 30 and operating system OS1 of virtual machine VM1 and operating system OS2 of virtual machine VM2. Channels 51, 53, CH1, and CH2 employ an advanced in-band management protocol (e.g., IPMI) that provides for virtual-machine specific interactions and messages. In an alternative embodiment, there are no explicit channels to virtual machines and guest operating systems.

Consoles 55 and 54 are designed for local viewing and editing of operating system and hardware parameter values, e.g., using a keyboard and a display. Management module 30 provides for emulating keyboard commands and forwarding display data to management station 11 to allow remote viewing and editing of these parameter values. Diagnostics suites M1 and MH are designed to capture and log software and hardware (or virtual-machine) events. Module 30 logs console and diagnostic events at 43. These can be remotely accessed over out-of-band network 17 via user interface 40.

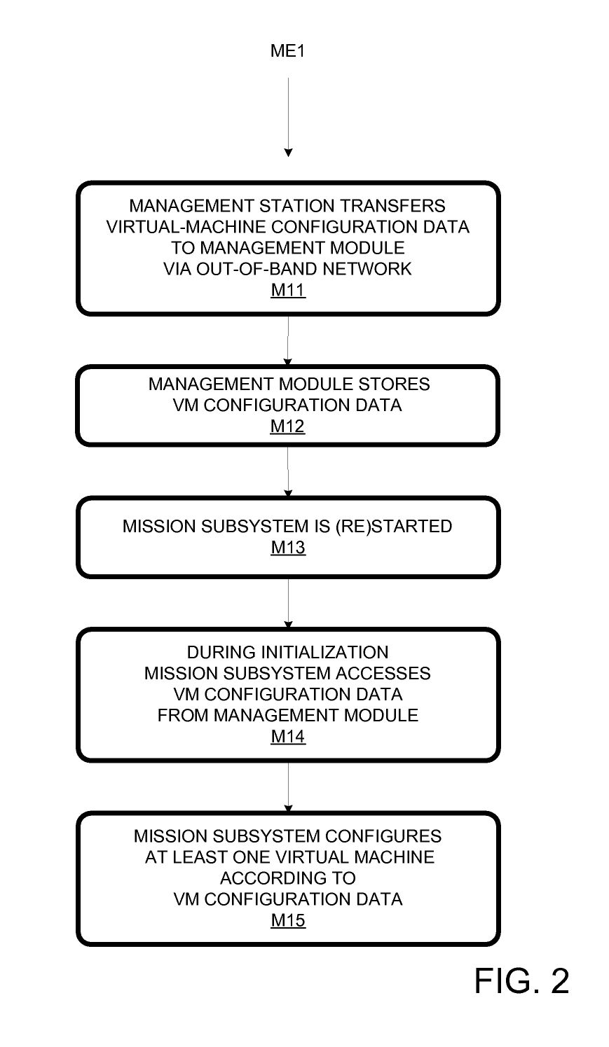

An instance of a method ME1 implemented in the context of system API is flow charted in FIGS. 2-4. As shown in FIG. 2, at method segment M11, a management station transfers virtual-machine configuration data to a management module via an out-of-band network. At method segment M12, the management module stores the VM configuration data, e.g., in a host and virtual-machine configuration database. Where the management module has its own power supply, the mission subsystem can be operating, or failed, or shutdown during method segments M11 and M12. In alternative embodiments, management modules and mission subsystems share one or more power supplies); in this configuration, a management module provides for management of a host computer and virtual machines as long as the common power supply is operating.

At method segment M13, the mission subsystem is started. This can involve powering on a mission subsystem that has been off or it can involve a hard or soft restart. In any case, mission subsystem is initialized. At method segment M14, during initialization, the mission subsystem accesses the configuration data on the management module. At method segment M15, the mission subsystem configures at least one virtual machine according to the virtual-machine configuration data stored on the management module. For example, processor, communications, and storage resources are assigned to virtual machines as specified by the configuration data. In general, all virtual machines configured during an initialization process are configured according to data in the management module.

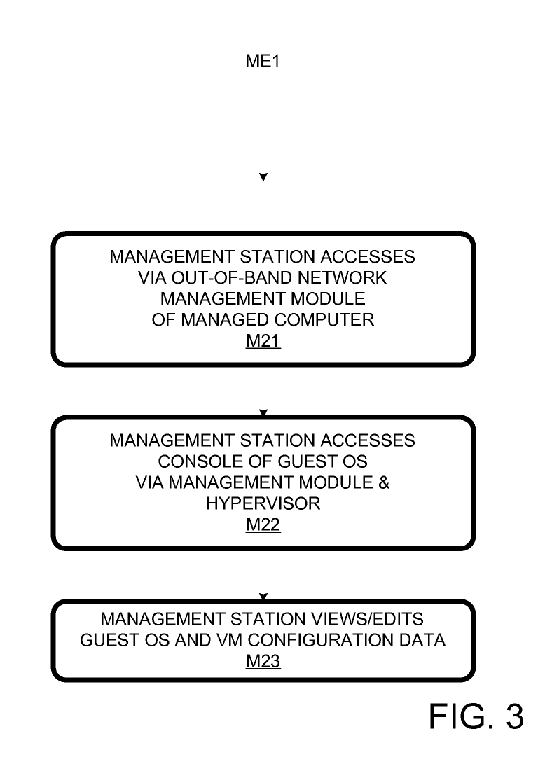

At method segment M21, FIG. 3, a management station accesses the management module via the out-of-band network. This allows the management station to access, at method segment M22, a console of a guest operating system through the management module and a hypervisor that runs on the mission subsystem and on which the guest-operating system runs. This console access allows the management station to view and/or edit configuration data for the guest operating system and the virtual machine on which it runs at method segment M23.

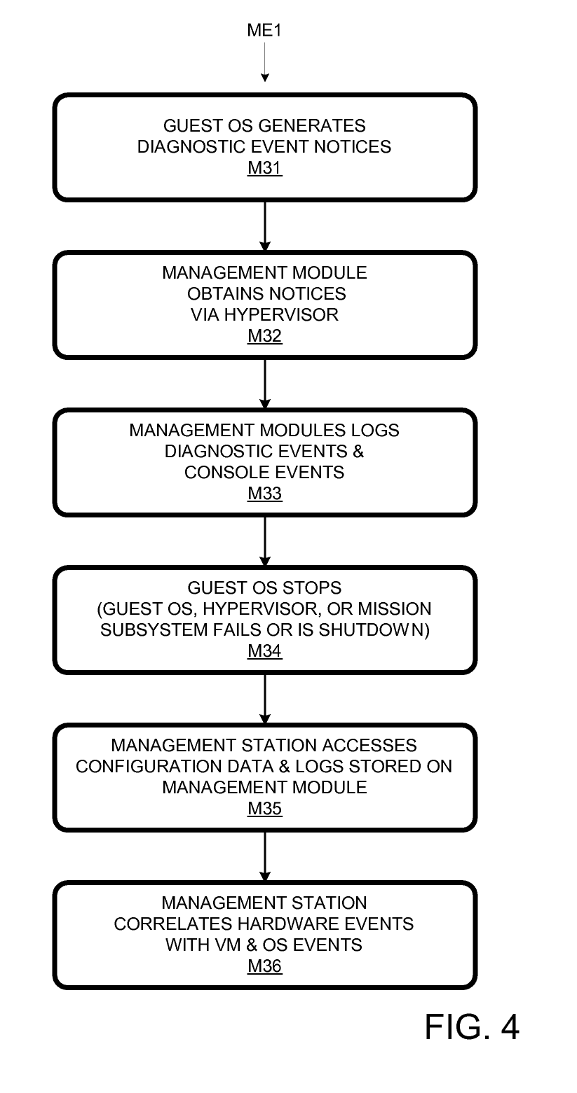

At method segment M31, FIG. 4, a guest operating system generates diagnostic events and notices thereof. These can involve detected errors, an unacceptable number of retries in sending a packet, etc. At method segment M32, the management module accesses, receives, or otherwise obtains these notices via the hypervisor. At method segment M33, the management module logs the diagnostic events. In addition, console events (accesses, changes) are logged. At method segment M35, the management station, accesses the configuration data and logs stored on the management module. Where the management module has an independent power supply, this access can occur even if the guest operating system is stopped, e.g., shut down or failed, as at method segment M34.

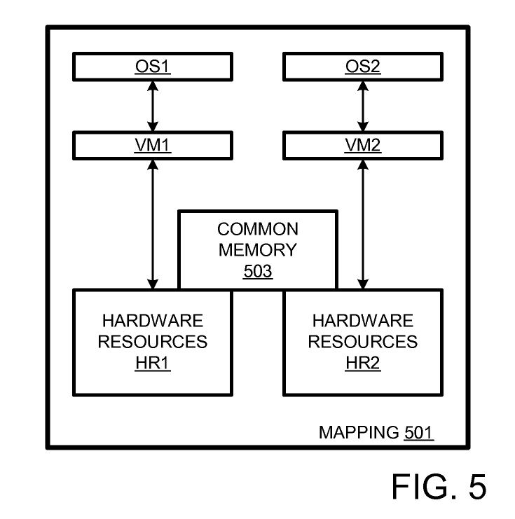

The hardware event logs can contain information about, for example, memory errors (e.g., in solid-state memory modules and disks), temperature events, power consumption, and processor speed. Software logs may contain information about faults and performance. The configuration data from database 45 maps operating systems to virtual machines and virtual machines to hardware resources, e.g., operating system OS1 and OS2 are mapped to virtual machines VM1 and VM2, respectively, and virtual machines VM1 and VM2 are mapped to hardware resources HR1 and HR2 (e.g., processors of processors 23, communications devices of communications devices 25, and memory devices of media 27 including common memory 503), as represented in mapping 501 of FIG. 5.

The configuration data of database 45 can specify how resources are allocated to virtual machines and thus to guest operating systems. As FIG. 5 suggests, the configuration data of database 45 can be used to help an administrator visualize the relationships between hardware resources, virtual machines, and operating systems. In addition, an analysis tool can use these relationships to correlate hardware events to the virtual machine, operating system, and application that uses the hardware. User interface 40 can present these correlations to an administrator or other user so that, for example, the administrator can recognize that an application's performance has been adversely affected by a failed memory module.

Providing an integrated out-of-band interface for managing hardware and virtual servers reduces the number of interfaces a system administrator needs to master to manage a complex computer system. In addition, the integrated interface allows hardware and virtual servers to be managed collectively without switching between interfaces. Managing virtual machines out-of-band addresses reliability and availability issues that can occur when virtual machines are managed in-band using tools to set up, configure and report that run on the managed server.

Moreover, higher level analysis tools can readily correlate events associated with virtual machines and events associated with the underlying hardware; for example, the integrated interface makes it easy to determine when a processor for a particular virtual machine has been throttled back for power savings. Such correlations would be difficult to identify without the integrated management interface. The user interface and associated analysis tools can provide for visualization of all the guest operating systems, virtual machines, and hardware resources, as well as the relations between them and their state of health. These and other utilities are provided by the described and other embodiments within the scope of the following claims.

What is claimed is:

1-20. (canceled)

21. A computer system comprising:
an out-of-hand management module having a management-module network interface; and
a mission subsystem including a mission console, a mission processor, and mission media, the mission media being encoded with code that when executed by the mission processor defines a virtual machine and a respective virtual console for the virtual machine, the respective virtual console being communicatively coupled to the management module network interface via the mission console and the out-of-band management module.

22. A computer system as recited in claim 21 wherein the code defines a hypervisor for hosting the virtual machine and creating the respective virtual console by virtualizing the mission console.

23. A computer system as recited in claim 21 wherein the mission subsystem has a mission power supply and the out-of-band management module has a management power supply separate from the mission power supply such that the virtual machine can be reconfigured via the out-of-band management module while the mission subsystem is off.

24. A computer system as recited in claim 21 comprising a management station coupled to a management network port over an out-of-band network for managing the virtual machine, the out-of-band management module including the management network port.

25. A computer system as recited in claim 24 wherein the mission subsystem includes a mission network port, the management station being communicatively coupled to the respective virtual console via an in-band network, the in-band network being separate from the out-of-band network.

26. A computer system as recited in claim 21 comprising shared memory shared by the out-of-band management module and the mission subsystem such that communication between the respective virtual console and the out-of-band management module is via the shared memory.

27. A computer system as recited in claim 21 wherein the out-of-band management module stores configuration data representing configurations for the virtual machine.

28. A virtual machine management process comprising:
creating, on a mission subsystem of a computer system, a virtual machine and a respective virtual console;
managing the virtual machine using the respective virtual console, the managing involving communications between a management station and the respective virtual console via a management module and via shared memory, the management module being communicatively coupled to the management station over an out-of-band network and the shared memory being shared by the management module and the mission subsystem.

29. A virtual machine management process as recited in claim 28 wherein the respective virtual console are created by virtualizing a mission console of the mission subsystem.

30. A virtual machine management process as recited in claim 28 comprising managing the virtual machine via an in-band network separate from the out-of-band network.

31. A virtual machine management process as recited in claim 28 wherein the managing includes reconfiguring a virtual machine while the mission subsystem is off.

32. A virtual machine management process as recited in claim 28 comprising accessing diagnostic and console data stored on the management module.
